(19) United States
(12) Patent Application Publication
(10) Pub. No.: US 2004/0204554 A1
(43) Pub. Date: Oct. 14, 2004

(54) Process for making a multifunctional superabsorbent polymer

(76) Inventors: Young Chan Ko, Neenah, WI (US); Stanley R. Kellenberger, Appleton, WI (US); Lee Kirby Jameson, Roswell, GA (US); Varunesh Sharma, Atlanta, GA (US)

Correspondence Address: Pauley Petersen Kinne & Erickson, Suite 365, 2800 W. Higgins Road, Hoffman Estates, IL, 60195, US

(21) Appl. No.: 10/410,579

(22) Filed: Apr. 9, 2003

(51) Int. Cl. C08F 4/30

(52) U.S. Cl. 526/229; 526/317.1

(57) ABSTRACT

A process for making a multifunctional superabsorbent polymer, and for making an absorbent structure containing superabsorbent polymer. The synthesis (i.e., polymerization) of the superabsorbent is completely integrated into the process for forming the multifunctional superabsorbent polymer and/or absorbent structure. More particularly, a monomer solution containing an oxidizing agent, a monomer solution containing a reducing agent, and at least one functional additive are combined to form the multifunctional superabsorbent polymer. A valve can be used to control the liquid drop sizes of the monomer solutions as well as of the oxidizing agent, reducing agent, and functional additive(s). The droplets can be collected on a substrate, resulting in the formation of an absorbent structure.

### BACKGROUND OF THE INVENTION

This invention is directed to a process for making a multifunctional absorbent material useful in tissue and wiping absorbent articles, personal care absorbent articles, medical absorbent articles and the like, in which a superabsorbent polymer component of the multifunctional absorbent material is synthesized during manufacture of the absorbent material.

Processes for making superabsorbent polymers which are useful in absorbent composite materials are known. One feature of known processes is that they typically require at least some separate process steps for polymerizing or partially polymerizing the superabsorbent material before it can be added to the forming process for the absorbent composite.

Mitsubishi Chemical Company has disclosed an in-situ redox polymerization technique in U.S. Pat. No. 5,962,068 and in PCT Application WO 00/55418. This technique uses acrylic acid-based monomers to produce superabsorbent polymer. For in-situ polymerization, two types of solution are prepared. One contains the monomer and an oxidizing agent, and the other contains the monomer and a reducing agent. When these two solutions meet, a polymerization reaction is initiated by a reaction of the oxidizing agent with the reducing agent. This technique uses a spray reactor for the in-situ redox polymerization. For a successful operation of such a spray reactor system, colliding the two solutions and then breaking the mixed solutions into smaller sizes are crucial.

Superabsorbent polymers made by these and other processes possess high absorbent capacity, but generally lack any additional functional characteristics.

There is thus a need or desire for a process for making multifunctional superabsorbent polymers and absorbent composites containing multifunctional superabsorbent polymers.

### SUMMARY OF THE INVENTION

This invention is directed to a process for making in-situ polymerized multifunctional superabsorbent polymer. The invention is also directed to a process for making an absorbent structure including in-situ polymerized superabsorbent polymer, and absorbent articles made from such superabsorbent polymers and absorbent structures.

The multifunctional superabsorbent polymer can be made by combining a monomer solution containing an oxidizing agent, a monomer solution containing a reducing agent, and one or more functional additives. Suitable functional additives may include perfumes, deodorants, lotions, medicinal agents, coloring agents, wetting agents, pH controlling agents, swelling control agents, antibacterial agents, electrolytes, or combinations of any of these additives. Other examples of functional additives that may be included in the method of the invention are foaming agents, surfactants, blowing agents, viscosity controlling agents, or combinations of any of these. Additionally, flexible binders, elastomers, cellulosic powder, microfibrillated cellulose, microcrystalline cellulose, staple fibers, surface cross-linking agents, or combinations of any of these may also be added to the formation of the superabsorbent polymer.

Because the monomer solutions initially contact each other in the presence of the functional additive(s), the polymerization reaction proceeds in combination with the functional additive(s), resulting in a multifunctional superabsorbent polymer.

The monomer solutions can be combined in various ways, including pumping each solution through a jetting device, hydraulic nozzle, or tube. Tubes may be connected to one another with a valve between them. The valve can be used to control liquid droplet sizes for combining the monomer solutions and for distributing the monomer solutions onto a substrate. Alternatively, a single monomer solution may be pumped through two different tubes, with an oxidizing agent pumped through a tube connected to one of the monomer solution tubes, and a reducing agent pumped through another tube connected to the other monomer solution tube. A valve can be used to control liquid droplet sizes for combining the stream of fluid including the monomer solution and the oxidizing agent with the stream of fluid including the monomer solution and the reducing agent, and for distributing the droplets onto a substrate.

With the foregoing in mind, it is a feature and advantage of the invention to provide a process for making multifunctional superabsorbent polymers and absorbent composites containing multifunctional superabsorbent polymers.

### BRIEF DESCRIPTION OF THE DRAWINGS

These and other objects and features of this invention will be better understood from the following detailed description taken in conjunction with the drawings, wherein:

FIGS. 1-12 are schematic diagrams of various embodiments of the method of the invention.

### Definitions

Within the context of this specification, each term or phrase below will include the following meaning or meanings.

The term “multifunctional” refers to a material or composition that possesses more than one functional characteristic, such as absorbency, scent, odor-absorption, pharmaceutical benefits, color enhancement, wettability, neutralization, swelling control, antibacterial effects, and the like.

The term “functional additive” refers to an additive that lends a functional characteristic to a composition, which characteristic was not present in the composition prior to addition of the functional additive.

The term “staple fibers” means filaments or fibers which are natural or which are cut from a manufactured filament prior to forming into a web, and which have a length ranging from about 0.1-15 cm, more commonly about 0.2-7 cm.

The term “polymer” generally includes but is not limited to, homopolymers, copolymers, including block, graft, random and alternating copolymers, terpolymers, etc. and blends and modifications thereof. Furthermore, unless otherwise specifically limited, the term “polymer” shall include all possible geometrical configurations of the material. These configurations include, but are not limited to isotactic, syndiotactic and atactic symmetries.

The term “monomer solution,” as used herein, refers to any and all solutions which, when mixed, chemically reacts to form a superabsorbent polymer. Each solution may be comprised of any combination of oligomer(s), monomer(s), cross-linking reagent(s), neutralizing agent, or initiator(s). In instances when only a single solution is utilized all the desired components must be in said solution and the initiator(s) must require a later activation step (e.g. heating or irradiation). In instances when two or more solutions are utilized the initiator(s) is most often, but not limited to, a chemical redox pair. When a redox pair, comprised of an oxidizing radical generator and a reducing agent, is used as the initiator the oxidizing radical generator and reducing agent must be in separate solutions. The solution of oxidizing radical generator or reducing agent may also contain any combination of oligomer(s), monomer(s), cross-linking reagent(s), or neutralizing agent.

The terms “elastic,” “elastomeric,” and “elastomer” are used interchangeably to mean a material that is generally capable of recovering its shape after deformation when the deforming force is removed. Specifically, as used herein, elastic or elastomeric is meant to be that property of any material which upon application of an elongating force, permits that material to be stretchable to a stretched length which is at least about 25 percent greater than its relaxed length, and that will cause the material to recover at least 40 percent of its elongation upon release of the stretching elongating force. A hypothetical example which would satisfy this definition of an elastomeric material would be a one (1) inch sample of a material which is elongatable to at least 1.25 inches and which, upon being elongated to 1.25 inches and released, will recover to a length of not more than 1.15 inches. Many elastic materials may be stretched by much more than 25 percent of their relaxed length, and many of these will recover to substantially their original relaxed length upon release of the stretching, elongating force.

The term “superabsorbent” refers to a water swellable, water-insoluble organic or inorganic material capable, under the most favorable conditions, of absorbing at least about 10 times its weight, preferably at least about 20 times its weight in an aqueous solution containing 0.9% by weight sodium chloride. The term “absorbent material” refers to any material capable of absorbing from about 5 to less than about 15 times its weight of the same solution.

The terms “micro-dispensing” and “micro-dispensation” are used herein to refer to the release of particles or droplets having a diameter of less than about 3000 micrometers, or less than about 700 micrometers, or even less than about 500 micrometers, wherein the diameter is the largest cross-sectional measure of the particle or droplet.

The term “tissue and wiping absorbent article” includes facial tissue, paper towels such as kitchen towels, away-from-home towels, wet-wipes, and the like.

The term “personal care absorbent article” includes diapers, training pants, swim wear, absorbent underpants, adult incontinence products, feminine hygiene products, and the like.

The term “medical absorbent article” includes medical absorbent garments, drapes, gowns, bandages, wound dressings, underpads, wipes, and the like.

These terms may be defined with additional language in the remaining portions of the specification.

### DESCRIPTION OF PREFERRED EMBODIMENTS

In accordance with the invention, a multifunctional superabsorbent polymer can be made by combining a monomer solution containing an oxidizing agent, a monomer solution containing a reducing agent, and one or more functional additives. The functional additive or additives can be combined with one or more of the monomer solutions before or during in-situ polymerization of the liquid monomers, thereby resulting in a superabsorbent polymer having one or more functional characteristics in addition to high absorbency.

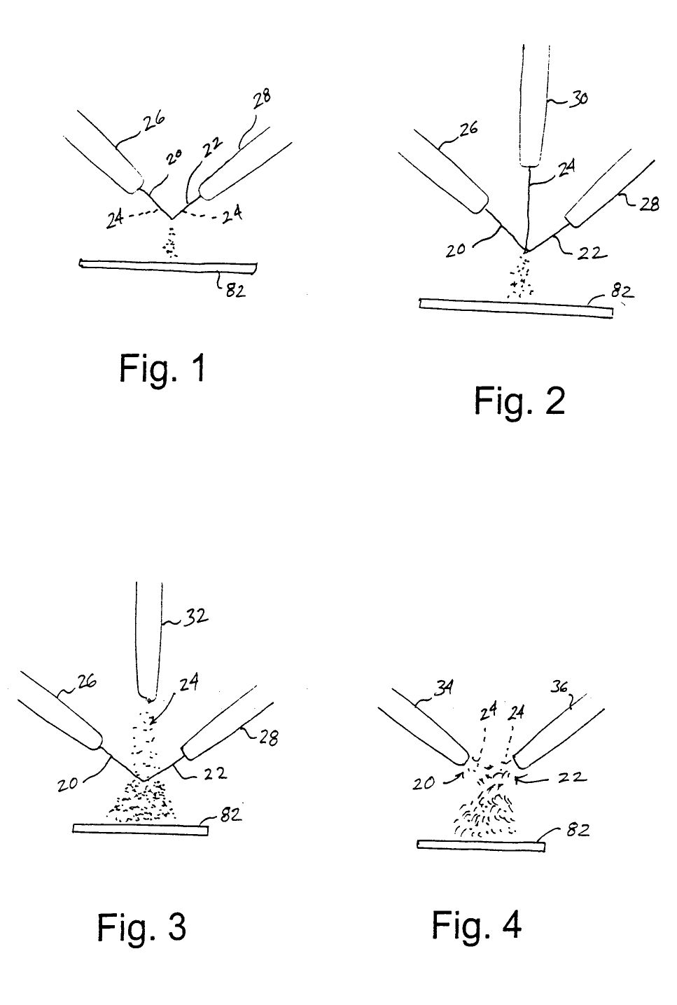

Schematic diagrams of producing the multifunctional superabsorbent polymer, and absorbent structure including the superabsorbent polymer, are illustrated in FIGS. 1-13. Two or more separate streams of superabsorbent polymer precursor monomer solution are combined to form an in-situ polymerizable monomer solution. By “separate streams” it is meant that the monomer solutions are poured from separate sources. For example, the monomer solutions can each be in the form of a continuous stream that breaks into droplets as the monomer solutions are combined. Jetting devices such as those that induce needle jets, tubes, or other suitable feeding devices can be used to provide such continuous streams. Additionally, particle size and shape can be controlled by the fluid pressure in and diameter and length of such feeding devices. Alternatively, each stream of monomer solution need not be continuous, but instead can be in droplet form, resulting in a stream of droplets as the monomer solutions are combined. Mechanical means, such as hydraulic spray nozzles or micro-solenoid valves or micro-dispensing valves as used in ink-jet printing, can be used to provide the droplets. The size of the liquid drops, and consequently the size of the resulting superabsorbent particles, can be controlled by the size of the nozzles or orifices of the spraying or micro-dispensing system(s), the applying pressure(s), and by controlling the viscosity of the solution(s) using viscosity controlling agent(s).

In one embodiment, illustrated in FIG. 1, the monomer solution containing the oxidizing agent 20 can be provided in a continuous stream through a first jetting device 26, and the monomer solution containing the reducing agent 22 can be provided in a continuous stream through a second jetting device 28. When the two streams meet, in-situ polymerization begins and the streams break into particles. The functional additive or additives 24 can be provided in combination with the monomer solution containing the oxidizing agent 20, or in combination with the monomer solution containing the reducing agent 22, or in combination with both monomer solutions 20, 22. Alternatively, as illustrated in FIG. 2, the functional additive or additives 24 can be provided in a continuous stream through a third jetting device 30. As yet another alternative, illustrated in FIG. 3, the functional additive or additives 24 can be provided in droplets through a hydraulic nozzle 32.

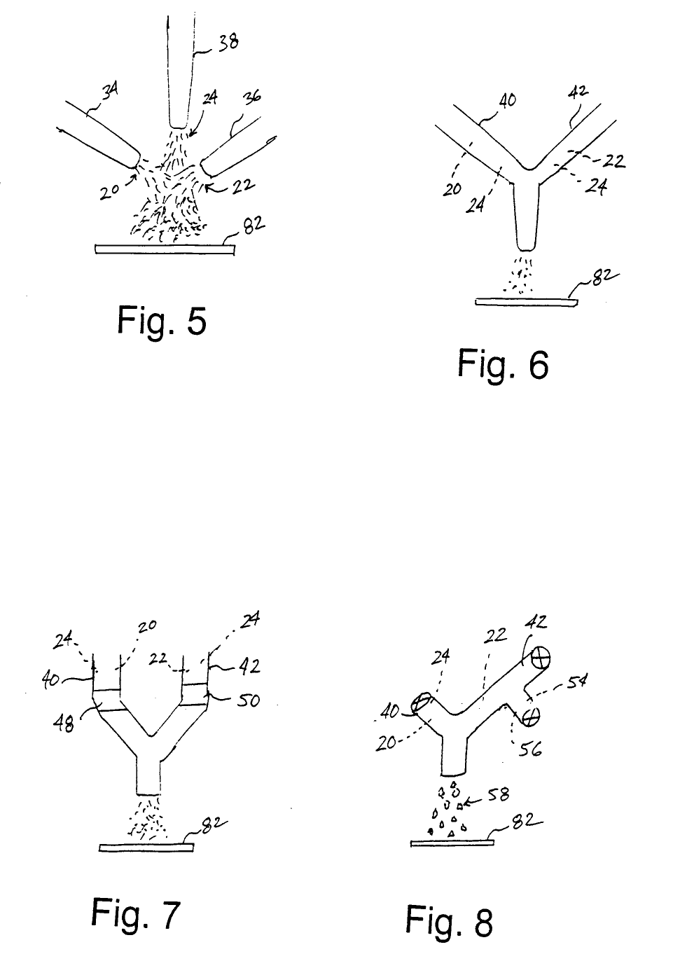

In another embodiment, illustrated in FIG. 4, the monomer solution containing the oxidizing agent 20 can be provided in droplets through a first hydraulic nozzle 34, and the monomer solution containing the reducing agent 22 can be provided in droplets through a second hydraulic nozzle 36. The functional additive or additives 24 can be provided in combination with the monomer solution containing the oxidizing agent 20, or in combination with the monomer solution containing the reducing agent 22, or in combination with both monomer solutions 20, 22. Alternatively, as illustrated in FIG. 5, the functional additive or additives 24 can be provided in droplets through a third hydraulic nozzle 38.

In another embodiment, illustrated in FIG. 6, the monomer solution containing the oxidizing agent 20 can be provided through a first tube 40, and the monomer solution containing the reducing agent 22 can be provided through a second tube 42 connected to the first tube 40. The functional additive or additives 24 can be provided in combination with the monomer solution containing the oxidizing agent 20, or in combination with the monomer solution containing the reducing agent 22, or in combination with both monomer solutions 20, 22. Additionally, in a plug-flow type reactor, micro-dispensing valves 48, 50 may be included within the first and/or second tubes 40, 42 to allow micro-dispensation of the monomer solutions, as illustrated in FIG. 7. Micro-dispensation of the monomer solutions breaks the streams into finite drops in each tube, resulting in the liquids coming together as finite drops while still enclosed within the tubes. A polymerizing stream of finite drops exits the tube system. Liquid drop sizes can be controlled through the size of tubes and valves, the length of time the valves are open, the size of the outlet, and/or through use of a porous, sprinkle device.

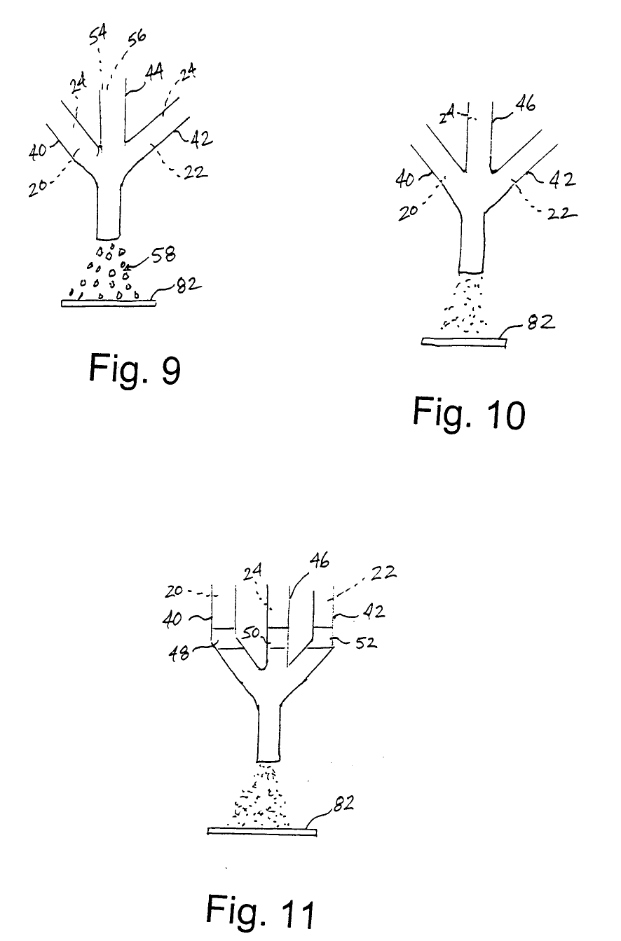

Furthermore, a foaming agent 54, such as a surfactant, and/or a blowing agent 56, such as critical CO₂, may also be provided in combination with the monomer solution containing the oxidizing agent 20, or in combination with the monomer solution containing the reducing agent 22, or in combination with both monomer solutions 20, 22, in any of the embodiments of the invention, suitably while the system is under pressure. One example of this embodiment is illustrated in FIG. 8. Alternatively, as illustrated in FIG. 9, a foaming agent 54 and/or a blowing agent 56 can be provided through a third tube 44 connected to the first and second tubes 40, 42. Foaming and/or blowing agents are suitably brought into a system while the system is under pressure, thereby resulting in instant expansion of the polymerizing superabsorbent particles 58 upon exiting the enclosure. Critically sized or valved outlets can be used to control the pressure. Furthermore, outlet tubes in any of the embodiments herein can be designed to ensure adequate mixing of the ingredients, and can be constructed out of or coated with non-stick materials, such as poly-tetra-fluoro-ethylene, available from E. I. du Pont de Nemours Co., under the trade name TEFLON®.

In another embodiment, illustrated in FIG. 10, the monomer solution containing the oxidizing agent 20 can be provided through the first tube 40, the monomer solution containing the reducing agent 22 can be provided through the second tube 42 connected to the first tube 40, and the functional additive or additives 24 can be provided through a third tube 46 connected to the first and second tubes 40, 42. Additionally, micro-dispensing valves 48, 50, 52 may be included within the first, second and/or third tubes 40, 42, 46 to allow micro-dispensation of the monomer solutions and/or the functional additives, as illustrated in FIG. 11.

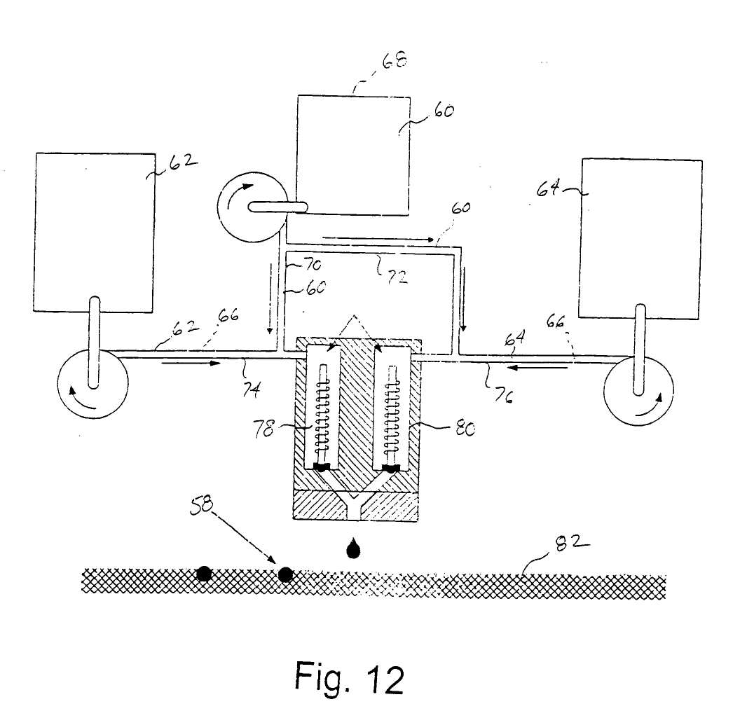

In yet another embodiment, illustrated in FIG. 12, a monomer solution 60 can be pumped from a single container 68 into a first tube 70 and a second tube 72. The first tube 70 and the second tube 72 are separated by first and second valves 78, 80. An oxidizing agent 62 can be pumped through a third tube 74 connected in-line to the first tube 70 to combine with the monomer solution 60 in the first tube 70. A reducing agent 64 can be pumped through a fourth tube 76 connected in-line to the second tube 72 to combine with the monomer solution 60 in the second tube 72. One or more functional additives 66 can be combined with the monomer solution 60, the oxidizing agent 62, and/or the reducing agent 64. The valves 78, 80 between the first and second tubes 70, 72 can be opened to allow the monomer solution 60, the oxidizing agent 62, and the reducing agent 64, as well as the functional additives 66, to combine. When the monomer solution 60, the oxidizing agent 62, the reducing agent 64, and the functional additives 66 combine, in-situ polymerization begins. As mentioned above, a porous sprinkle device can be attached to each valve 78, 80 to control the droplet sizes of the liquid expelled from the tubes, and/or a porous sprinkle device can be embedded in the combined outlet from valves 78 and 80.

In each of the embodiments of the method of the invention, the resulting in-situ polymerized superabsorbent polymer can be collected, as a stream or in droplets, in or on a substrate 82 below the jetting devices, hydraulic nozzles, tubes, and/or valves. The substrate 82 may be any suitable material upon which an absorbent layer may be formed, or into which absorbent particles may be incorporated. The substrate 82 can be wet-formed like paper (ranging from tissue to towel to board and the like) or dry formed (bonded carded webs, spunbonded webs, meltblown webs, cross-laid scrims, air laid webs, and the like). Examples of suitable substrates 82 include nonwoven webs, woven webs, cloth or scrim, elastomeric webs, film, foam and combinations thereof. Furthermore, the droplets of the reactants may mix in-flight before reaching the substrate 82, or the droplets may mix on the substrate 82. Add-on level of in-situ polymerized superabsorbent particles onto a substrate 82 may be controlled by the size of pumps, pipes, and nozzles, and the number of outlets and valves used in the process.

The multifunctional superabsorbent polymer made according to the method of the invention may contain residual water and a small amount of unreacted monomers and extractables. The excess water, unreacted monomers, and extractables can be removed from and/or further reacted in the superabsorbent polymer by drying the superabsorbent polymer using such methods as flash, through-air, drum, infrared, and microwave heat drying, and UV or electron-beam curing.

The superabsorbent polymer precursor monomer solutions can be selected so that they do not polymerize or otherwise chemically react before they make contact with each other. Upon colliding the streams, in-situ polymerization of the superabsorbent starts instantly, or almost instantly, with a conversion rate of about 50%-90% within less than about 5 seconds, under suitable conditions. The in-situ polymerization results in the functional additives being entrapped within the superabsorbent particles.

A wide variety of superabsorbent polymer precursor monomer solutions, or compositions, may be employed in the process of the invention. At least one polymer precursor composition may include a monomer. Suitable superabsorbent-forming monomers include the following monomers, and combinations thereof:

1. Carboxyl group-containing monomers: monoethylenically unsaturated mono or poly-carboxylic acids, such as (meth)acrylic acid (meaning acrylic acid or methacrylic acid. Similar notations are used hereinafter), maleic acid, fumaric acid, crotonic acid, sorbic acid, itaconic acid, and cinnamic acid;

2. Carboxylic acid anhydride group-containing monomers: monoethylenically unsaturated polycarboxylic acid anhydrides (such as maleic anhydride);

3. Carboxylic acid salt-containing monomers: water-soluble salts (alkali metal salts, ammonium salts, amine salts, etc.) of monoethylenically unsaturated mono- or poly-carboxylic acids (such as sodium (meth)acrylate, trimethylamine (meth)acrylate, triethanolamine (meth)acrylate, sodium maleate, methylamine maleate;

4. Sulfonic acid group-containing monomers: aliphatic or aromatic vinyl sulfonic acids (such as vinylsulfonic acid, allyl sulfonic acid, vinyltoluenesulfonic acid, styrene sulfonic acid), (meth)acrylic sulfonic acids [such as sulfopropyl (meth)acrylate, 2-hydroxy-3-(meth)acryloxy propyl sulfonic acid];

5. Sulfonic acid salt group-containing monomers: alkali metal salts, ammonium salts, amine salts of sulfonic acid group containing monomers as mentioned above;

6. Hydroxyl group-containing monomers: monoethylenically unsaturated alcohols [such as (meth)allyl alcohol], monoethylenically unsaturated ethers or esters of polyols (alkylene glycols, glycerol, polyoxyalkylene polyols), such as hydroxethyl (meth)acrylate, hydroxypropyl (meth)acrylate, triethylene glycol (meth)acrylate, poly(oxyethylene oxypropylene) glycol mono (meth)allyl ether (in which hydroxyl groups may be etherified or esterified);

7. Amide group-containing monomers: vinylformamide, (meth)acrylamide, N-alkyl (meth)acrylamides (such as N-methylacrylamide, N-hexylacrylamide), N,N-dialkyl (meth)acryl amides (such as N,N-dimethylacrylamide, N,N-di-n-propylacrylamide), N-hydroxyalkyl (meth)acrylamides [such as N-methylol (meth)acrylamide, N-hydroxyethyl (meth)acrylamide, N,N-dihydroxyalkyl (meth)acrylamides [such as N,N-dihydroxyethyl (meth)acrylamidel, vinyl lactams (such as N-vinylpyrrolidone);

8. Amino group-containing monomers: amino group-containing esters (e.g., dialkylaminoalkyl esters, dihydroxyalkylaminoalkyl esters, morpholinoalkyl esters, etc.) of monoethylenically unsaturated mono-or di-carboxylic acid [such as dimethiaminoethyl (meth)acrylate, diethylaminoethyl (meth)acrylate, morpholinoethyl (meth)acrylate, dimethyl aminoethyl fumarate, heterocyclic vinyl compounds such as vinyl pyridines (e.g., 2-vinyl pyridine, 4-vinyl pyridine, N-vinyl pyridine), N-vinyl imidazole;

9. Quaternary ammonium salt group-containing monomers: N,N,N-trialkyl-N-(meth)acryloyloxyalkylammonium salts [such as N,N,N-trimethyl-N-(meth) acryloyloxyethylammonium chloride, N,N,N-triethyl-N-(meth)acryloyloxyethylammonium chloride, 2-hydroxy-3-(meth)-acryloyloxypropyl trimethyl ammonium chloride]; and

10. Ether-group containing monomers: methoxy polyethylene glycol (meth)acrylate; polyethylene glycol dimethacrylate.

Desirable superabsorbent-forming monomers suitable for the process of the invention include without limitation aliphatic unsaturated monocarboxylic acids or salts thereof; specifically unsaturated monocarboxylic acids or salts thereof such as acrylic acid or salts thereof, methacrylic acid or salts thereof, or unsaturated dicarboxylic acids or salts thereof such as maleic acid or salts thereof, itaconic acid or salts thereof, which may be used alone or in combination.

Among these, acrylic acid or salts thereof and methacrylic acid or salts thereof are preferred, with especially preferred being acrylic acid or salts thereof.

For example, 37.5% by weight of an 80% by weight aqueous solution of acrylic acid, to which 49.3% by weight of a 25.4% by weight aqueous solution of caustic soda may be added dropwise with the application of external cooling to neutralize to 75 mole % of the acrylic acid. Thereafter, 2.1% by weight of N,N′-methylene-bis-acrylamide may be dissolved in the resulting solution to obtain as feed monomer solution (1), an aqueous solution of a partially neutralized salt of acrylic acid, giving a monomer concentration of 42.3% by weight.

To prepare a monomer solution containing a reducing agent (Solution A), 0.73 part by weight of ascorbic acid may be mixed with and dissolved in 100 parts by weight of the feed monomer solution (1). To prepare a monomer solution containing an oxidizing agent (Solution B), 2.5 parts by weight of an aqueous solution of hydrogen peroxide having a concentration of 31% by weight may be mixed and homogenized with 100 parts by weight of the same feed monomer solution (1).

Polymerizable monomers giving a water-absorbing polymer in the present invention are preferably aliphatic unsaturated carboxylic acids or salts thereof as described above, therefore, aqueous solutions of these polymerizable monomers are preferably aqueous solutions essentially containing an aliphatic unsaturated carboxylic acid or a salt thereof. As used herein, the expression “essentially containing an aliphatic unsaturated carboxylic acid or a salt thereof” means that the aliphatic unsaturated carboxylic acid or a salt thereof is contained at 50 mol % or more, preferably 80 mol % or more on the basis of the total amount of the polymerizable monomer.

Suitable salts of aliphatic unsaturated carboxylic acids normally include water-soluble salts such as alkali metal salts, alkali earth metal salts, ammonium salts or the like. The neutrality is appropriately selected depending on the purpose, but 20-90 mol % of carboxyl group is preferably neutralized with an alkali metal salt or an ammonium salt in the case of acrylic acid. If the partial neutrality of an acrylic monomer is less than 20 mol %, the resulting water-absorbing polymer tends to have low water-absorbing capacity.

Acrylic monomers can be neutralized with alkali metal hydroxides or bicarbonates or ammonium hydroxide or the like, preferably alkali metal hydroxides such as sodium hydroxide and potassium hydroxide.

Superabsorbent-forming monomers may also include comonomers which are polymerizable along with any of the monomers listed above. The comonomers may form part of the same superabsorbent polymer precursor composition as the primary monomer, or may be part of a different superabsorbent polymer precursor composition, and may be added to the fibrous mixture using the same or different streams. While it may be desirable in some instances to add comonomers in different superabsorbent polymer precursor compositions, they may be added in the same precursor composition as the primary monomer if the primary monomer and comonomer will not spontaneously react with each other. Where the primary monomer is an aliphatic unsaturated carboxylic acid, suitable comonomers include without limitation secondary monomers such as (meth)acrylamide, (poly)ethylene glycol (meth)acrylate, 2-hydroxyethyl (meth)acrylate or even slightly water-soluble monomers including acrylate capped urethanes, acrylic alkyl esters such as methyl acrylate or ethyl acrylate may also be copolymerized in an amount within a range that does not affect performance of the resulting water-absorbing polymers in the present invention. As used herein, the term “(meth)acryl” means both “acryl” and “methacryl.”

Aliphatic unsaturated carboxylic acids or salts thereof, especially acrylic acid or salts thereof sometimes form a self-cross-linked polymer by themselves, but may be positively induced to form a cross-linked structure using a cross-linker. The use of a cross-linker normally improves water-absorbing performance of the resulting water-absorbing polymer. Preferably, suitable cross-linkers include divinyl compounds copolymerizable with said polymerizable monomers such as N,N′-methylenebis(meth)acrylamide, (poly)ethylene glycol di(meth)acrylate and water-soluble compounds having two or more functional groups capable of reacting with a carboxylic acid including polyglycidyl ethers such as ethylene glycol diglycidyl ether, polyethylene glycol diglycidyl ether. Among them, N,N′-methylenebis (meth)acrylamide is especially preferred. Cross-linkers are used in an amount of 0.001-1% by weight, preferably 0.01-0.5% by weight on the basis of the amount of the monomer, and may be added in the same superabsorbent polymer precursor composition as the monomer, or as part of a different precursor composition.

One or more polymerization initiators may be added in a different superabsorbent polymer precursor composition than the monomer(s). The polymerization initiator may be added as part of the same precursor composition as the monomer if the initiator is a single component of a redox pair. Alternatively, the polymerization initiators may be added as part of a different precursor composition as the monomer due to the fact that the polymerization initiators may act quickly to polymerize the monomer units once contact is made. When the monomer and polymerization initiator make initial contact in an in-situ polymerization superabsorbent (ISPS) reactor, the polymerization reaction is initiated, and continues within the ISPS reactor until the desired level of polymerization is completed, at which time the combined polymerizing monomer and polymerization initiator exit the ISPS reactor and are combined with other material to form a composite wherein polymerization is completed. The level of polymerization achieved before exiting the ISPS reactor is controlled by pressure, temperature, valves and length of the ISPS reactor, and the like. An absorbent composite can be formed using such equipment as RANDO-FEEDER volumetric feeders using vacuum, conveyor speed and height of scarfing pin rolls, and the like.

Polymerization initiators suitable for the present invention include without limitation somewhat water-soluble redox systems combining an oxidizing radical generator and a reducing agent. Such oxidizing agents include hydrogen peroxide, potassium bromate, N-bromosuccinimide, persulfates such as ammonium persulfate, sodium persulfate, or potassium persulfate, peroxides including hydroperoxides such as 1-butyl hydroperoxide or cumene hydroperoxide, secondary cerium salts, permanganates, chlorites, hypochlorites, etc., among which hydrogen peroxide is especially preferred. These oxidizing agents may be used in an amount of 0.001-10% by weight, desirably 0.01-2% by weight on the basis of polymerizable monomers.

Reducing agents are also used with the redox system, and may be added as part of the polymerization initiator. Suitable reducing agents are capable of forming a redox system with said oxidizing agents, specifically sulfites such as sodium sulfite or sodium hydrogensulfite, sodium thiosulfate, cobalt acetate, copper sulfate, ferrous sulfate, ferrous ammonium sulfate, sodium metabisulfite, tertiary amines or diamines, L-ascorbic acid or L-ascorbic acid alkali metal salts, etc. Among others, L-ascorbic acid or L-ascorbic acid alkali metal salts are especially preferred. These reducing agents are used in an amount of 0.001-10% by weight, preferably 0.01-2% by weight on the basis of polymerizable monomers. Desirably, the precursor composition containing the oxidizing radical generator is added using a different addition stream than is used for the reducing agents.

Where a redox system of polymerization initiator(s) as described above is employed, the chemical reaction proceeds spontaneously. Otherwise, depending on the mechanism of chemical reaction employed, it may be necessary to raise the temperature within the ISPS reactor, irradiate it, or employ some other treatment in order to facilitate and optimize the chemical reaction.

In one embodiment of the invention, a first superabsorbent polymer precursor composition may contain all of the essential polymerization ingredients except for one initiator, which can be either an oxidizing agent or a reducing agent. The second superabsorbent polymer precursor composition may contain only that one initiator. When the first and second superabsorbent polymer precursor compositions come in contact with each other in the ISPS reactor, the chemical reaction proceeds spontaneously to form superabsorbent polymer.

In one embodiment of the invention, the first and second superabsorbent polymer precursor compositions are combined in the ISPS reactor, and are chemically reacted to form a superabsorbent polymer. Then, to further advance and complete the chemical reaction, a third superabsorbent polymer precursor composition (for instance, one containing a second polymerization initiator or a second quantity of an original polymerization initiator) is added to the ISPS reactor.

Examples of superabsorbent polymers which may be formed in situ include without limitation the alkali metal and ammonium salts of poly(acrylic acid) and poly(methacrylic acid), poly(acrylamides), poly(vinyl ethers), maleic anhydride copolymers with vinyl ethers and alpha-olefins, poly(vinyl pyrrolidone), poly(vinylmorpholinone), poly(vinyl alcohol), and mixtures and copolymers thereof. Further superabsorbent materials (some of which may be formed before addition to the ISPS reactor) include natural and modified natural polymers, such as hydrolyzed acrylonitrile-grafted starch, acrylic acid grafted starch, methyl cellulose, chitosan, carboxymethyl cellulose, hydroxypropyl cellulose, and the natural gums, such as alginates, xanthan gum, locust bean gum and the like. Mixtures of natural and wholly or partially synthetic superabsorbent polymers can also be useful in the present invention. Other suitable absorbent gelling materials are disclosed by Assarsson et al. in U.S. Pat. No. 3,901,236 issued Aug. 26, 1975. Known processes for preparing synthetic absorbent gelling polymers are disclosed in U.S. Pat. No. 4,076,663 issued Feb. 28, 1978 to Masuda et al. and U.S. Pat. No. 4,286,082 issued Aug. 25, 1981 to Tsubakimoto et al.

Various types of functional additives can be included in the superabsorbent polymers made according to the method of the invention. Such functional additives may include perfumes, deodorants, lotions, medicinal agents, coloring agents, wetting agents, pH controlling agents, swelling control agents, antibacterial agents, electrolytes, and combinations of any of these additives.

In addition, other ingredients can be chosen from the group including poly(ethylene glycol) acrylate, poly(ethylene glycol) methacrylate, poly(propylene glycol) acrylate, poly (propylene glycol) methacrylate, methoxy poly(propylene glycol) acrylate, methoxy poly(propylene glycol) methacrylate, hydroxyethyl acrylate, hydroxyethyl methacrylate, glyceryl acrylate, and glyceryl methacrylate to be included in the material in the method of the invention to toughen and/or rubberize the superabsorbent polymer. Other additional agents, such as foaming agents, blowing agents, viscosity controlling agents, and/or surfactants, can be added to one or more of the monomer solutions to generate desirable morphologies of the resulting superabsorbent particles. For example, foaming agents and/or blowing agents can be used to create superabsorbent particles having greater surface area than superabsorbent particles created without foaming agents and/or blowing agents. As another example, a viscosity controlling agent and/or a surfactant can be used to enhance control over the shape generation of the superabsorbent particles.

If necessary, a surface cross-linking agent may be added after the in-situ polymerized superabsorbent has taken on its final form, namely between some time after the bulk polymerization/cross-linking has begun to after bulk polymerization/cross-linking completion or even after completion of drying. Examples of suitable surface cross-linking agents include any polyfunctional compounds that are copolymerizable with polymerizable monomers, such as N,N′-methylenebis(meth)acrylamide and (poly)ethylene glycol bis(meth)acrylate, or compounds having some functional groups capable of reacting with a carboxylic acid group, such as (poly)ethylene glycol diglycidyl ether.

If desired, flexible binders, elastomers, fine fibers such as microfibrillated cellulose or microcrystalline cellulose, cellulosic powder, staple fibers, or combinations of any of these may be added to one or more of the monomer solutions to further enhance the functional capabilities of the superabsorbent polymer made according to the method of the invention.

The resulting multifunctional superabsorbent polymer, and absorbent structures including the multifunctional superabsorbent polymer, possesses one or more functional capabilities in addition to having absorbency. Therefore, an absorbent composite including the multifunctional superabsorbent polymer exhibits characteristics that are not possessed by conventional superabsorbent polymers. Furthermore, the method of making in-situ polymerized multifunctional superabsorbent polymer enables control over superabsorbent particle size, add-on level, placement and containment within an absorbent structure. Additionally, the method can be used to produce a high yield or output of the superabsorbent polymer because the particles do not encounter a sticking problem as in other processes.

The multifunctional superabsorbent polymer, and absorbent structures and absorbent composites including the multifunctional superabsorbent polymer, made in accordance with the invention is useful in a wide variety of absorbent articles, particularly in tissue and wiping absorbent articles, absorbent core material in personal care absorbent articles, and medical absorbent articles. Tissue and wiping absorbent articles include facial tissue, paper towels such as kitchen towels, away-from-home towels, wet-wipes, and the like. Personal care absorbent articles include diapers, training pants, swim wear, absorbent underpants, baby wipes, adult incontinence products, feminine hygiene products and the like. Medical absorbent articles include medical absorbent garments, drapes, gowns, bandages, wound dressings, underpads, wipes, and the like.

While the embodiments of the invention disclosed herein are presently preferred, various modifications and improvements can be made without departing from the spirit and scope of the invention. The scope of the invention is indicated by the appended claims, and all changes that fall within the meaning and range of equivalents are intended to be embraced therein.

What is claimed is:

1. A method of making a multifunctional superabsorbent polymer, comprising the steps of:
providing a monomer solution containing an oxidizing agent;
providing a monomer solution containing a reducing agent;
providing at least one functional additive; and
combining the monomer solution containing the oxidizing agent, the monomer solution containing the reducing agent, and the at least one functional additive to form a plurality of multifunctional superabsorbent polymer particles.

2. The method of claim 1, wherein the monomer solution containing the oxidizing agent comprises partially neutralized aqueous acrylic acid.

3. The method of claim 1, wherein the monomer solution containing the reducing agent comprises partially neutralized aqueous acrylic acid.

4. The method of claim 1, wherein the oxidizing agent comprises an aqueous hydrogen peroxide solution.

5. The method of claim 1, wherein the reducing agent comprises an aqueous ascorbic acid solution.

6. The method of claim 1, wherein the monomer solution containing the oxidizing agent further comprises a cross-linking agent.

7. The method of claim 1, wherein the monomer solution containing the reducing agent further comprises a cross-linking agent.

8. The method of claim 1, wherein the at least one functional additive is selected from the group consisting of perfumes, deodorants, lotions, medicinal agents, coloring agents, wetting agents, pH controlling agents, swelling control agents, antibacterial agents, electrolytes, and combinations thereof.

9. The method of claim 1, wherein the at least one functional additive is combined with the monomer solution containing the oxidizing agent prior to combining the monomer solution containing the oxidizing agent with the monomer solution containing the reducing agent.

10. The method of claim 1, wherein the at least one functional additive is combined with the monomer solution containing the reducing agent prior to combining the monomer solution containing the oxidizing agent with the monomer solution containing the reducing agent.

11. The method of claim 1, further comprising the step of adding at least one of the group consisting of a foaming agent, a surfactant, a blowing agent, a viscosity controlling agent, and combinations thereof to at least one of the monomer solution containing the oxidizing agent and the monomer solution containing the reducing agent.

12. The method of claim 1, further comprising the step of adding at least one of the group consisting of flexible binders, elastomers, cellulosic powder, microfibrillated cellulose, microcrystalline cellulose, staple fibers, surface cross-linking agents, and combinations thereof to at least one of the monomer solution containing the oxidizing agent and the monomer solution containing the reducing agent.

13. The method of claim 1, comprising combining the monomer solution containing the oxidizing agent and the monomer solution containing the reducing agent each in a continuous stream that breaks into droplets as the monomer solutions are combined.

14. The method of claim 1, comprising combining the monomer solution containing the oxidizing agent and the monomer solution containing the reducing agent each in droplet form.

15. The method of claim 1, comprising the steps of providing the monomer solution containing the oxidizing agent through a first jetting device; providing the monomer solution containing the reducing agent through a second jetting device; and providing the at least one functional additive through at least one of the first and second jetting devices.

16. The method of claim 1, comprising the steps of providing the monomer solution containing the oxidizing agent through a first jetting device; providing the monomer solution containing the reducing agent through a second jetting device; and providing the at least one functional additive through a third jetting device.

17. The method of claim 1, comprising the steps of providing the monomer solution containing the oxidizing agent through a first jetting device; providing the monomer solution containing the reducing agent through a second jetting device; and providing the at least one functional additive through a hydraulic nozzle.

18. The method of claim 1, comprising the steps of providing the monomer solution containing the oxidizing agent through a first hydraulic nozzle; providing the monomer solution containing the reducing agent through a second hydraulic nozzle; and providing the at least one functional additive through at least one of the first and second hydraulic nozzles.

19. The method of claim 1, comprising the steps of providing the monomer solution containing the oxidizing agent through a first hydraulic nozzle; providing the monomer solution containing the reducing agent through a second hydraulic nozzle; and providing the at least one functional additive through a third hydraulic nozzle.

20. The method of claim 1, comprising the steps of providing the monomer solution containing the oxidizing agent through a first tube; providing the monomer solution containing the reducing agent through a second tube connected to the first tube; and providing the at least one functional additive through at least one of the first and second tubes.

21. The method of claim 20, further comprising the steps of micro-dispensing the monomer solution containing the oxidizing agent through the first tube, and micro-dispensing the monomer solution containing the reducing agent through the second tube.

22. The method of claim 20, further comprising the step of providing at least one of a foaming agent and a blowing agent through at least one of the first and second tubes.

23. The method of claim 20, further comprising the step of providing at least one of a foaming agent and a blowing agent through a third tube connected to the first and second tubes.

24. The method of claim 1, comprising the steps of providing the monomer solution containing the oxidizing agent through a first tube; providing the monomer solution containing the reducing agent through a second tube connected to the first tube; and providing the at least one functional additive through a third tube connected to the first and second tubes.

25. The method of claim 24, further comprising the steps of micro-dispensing the monomer solution containing the oxidizing agent through the first tube; micro-dispensing the monomer solution containing the reducing agent through the second tube; and micro-dispensing the at least one functional additive through the third tube.

26. The method of claim 1, further comprising the step of drying the plurality of multifunctional superabsorbent polymer particles.

27. The method of claim 1, further comprising the step of collecting the multifunctional superabsorbent polymer particles on a substrate.

28. The method of claim 1, further comprising the step of collecting the multifunctional superabsorbent polymer particles in combination with a fibrous material to form an absorbent composite.

29. An absorbent article comprising the multifunctional superabsorbent polymer made according to the method of claim 1.

30. A method of making an absorbent structure, comprising the steps of:
pumping a monomer solution containing an oxidizing agent through a first tube;
pumping a monomer solution containing a reducing agent through a second tube connected to the first tube;
opening a valve between the first tube and the second tube, thereby allowing the monomer solution containing the oxidizing agent to combine with the monomer solution containing the reducing agent; and
collecting droplets of the combined monomer solutions on a substrate below the valve.

31. The method of claim 30, wherein the valve comprises a micro-dispensing valve that releases micro-droplets.

32. The method of claim 30, wherein the valve comprises a first micro-dispensing valve in the first tube and a second micro-dispensing valve in the second tube.

33. The method of claim 30, wherein the monomer solution containing the oxidizing agent comprises partially neutralized aqueous acrylic acid.

34. The method of claim 30, wherein the monomer solution containing the reducing agent comprises partially neutralized aqueous acrylic acid.

35. The method of claim 30, wherein the oxidizing agent comprises an aqueous hydrogen peroxide solution.

36. The method of claim 30, wherein the reducing agent comprises an aqueous ascorbic acid solution.

37. The method of claim 30, further comprising the step of adding at least one functional additive to at least one of the monomer solutions, wherein the at least one functional additive is selected from the group consisting of perfumes, deodorants, lotions, medicinal agents, coloring agents, wetting agents, pH controlling agents, swelling control agents, antibacterial agents, electrolytes, and combinations thereof.

38. The method of claim 30, further comprising the step of adding at least one of the group consisting of a foaming agent, a surfactant, a blowing agent, a viscosity controlling agent, and combinations thereof to at least one of the monomer solutions.

39. The method of claim 30, further comprising the step of adding at least one of the group consisting of flexible binders, elastomers, cellulosic powder, microfibrillated cellulose, microcrystalline cellulose, staple fibers, surface cross-linking agents, and combinations thereof to at least one of the monomer solutions.

40. A method of making an absorbent structure, comprising the steps of:
pumping a monomer solution through a first tube and a second tube;
pumping an oxidizing agent through a third tube connected to the first tube;
pumping a reducing agent through a fourth tube connected to the second tube;
opening a valve system between the third tube and the fourth tube, thereby allowing the monomer solution, the oxidizing agent, and the reducing agent to combine outside of the third and fourth tubes; and
collecting droplets of the combined monomer solution, oxidizing agent, and reducing agent on a substrate below the valve.

41. The method of claim 40, wherein the valve system comprises a micro-dispensing valve system that releases micro-droplets.

42. The method of claim 40, wherein the valve system comprises a first micro-dispensing valve in the third tube and a second micro-dispensing valve in the fourth tube.

43. The method of claim 40, wherein the monomer solution comprises partially neutralized aqueous acrylic acid.

44. The method of claim 40, wherein the oxidizing agent comprises an aqueous hydrogen peroxide solution.

45. The method of claim 40, wherein the reducing agent comprises an aqueous ascorbic acid solution.

46. The method of claim 40, further comprising the step of adding at least one functional additive to the monomer solution, wherein the at least one functional additive is selected from the group consisting of perfumes, deodorants, lotions, medicinal agents, coloring agents, wetting agents, pH controlling agents, swelling control agents, antibacterial agents, electrolytes, and combinations thereof.

47. The method of claim 40, further comprising the step of adding at least one of the group consisting of a foaming agent, a surfactant, a blowing agent, a viscosity controlling agent, and combinations thereof to the monomer solution.

48. The method of claim 40, further comprising the step of adding at least one of the group consisting of flexible binders, elastomers, cellulosic powder, microfibrillated cellulose, microcrystalline cellulose, staple fibers, surface cross-linking agents, and combinations thereof to the monomer solution.
